(19) United States
(12) Patent Application Publication
(10) Pub. No.: US 2019/0270922 A1
(43) Pub. Date: Sep. 5, 2019

(54) MAGNETIZABLE AGGLOMERATE ABRASIVE PARTICLES, ABRASIVE ARTICLES, AND METHODS OF MAKING THE SAME

(71) Applicant: 3M INNOVATIVE PROPERTIES COMPANY, St. Paul, MN (US)

(72) Inventors: Negus B. Adefris, Woodbury, MN (US); Gary M. Palmgren, Lake Elmo, MN (US); Joseph B. Eckel, Vadnais Heights, MN (US); Aaron K. Nienaber, Maplewood, MN (US); Thomas J. Nelson, St. Paul, MN (US); Mark A. Lukowski, St. Paul, MN (US); Vincent R. Jansen, Stillwater, MN (US)

(21) Appl. No.: 16/344,289

(22) PCT Filed: Sep. 27, 2017
(86) PCT No.: PCT/US2017/053705

§ 371 Date: Apr. 23, 2019

Related U.S. Application Data
(60) Provisional application No. 62/412,416, filed on Oct. 25, 2016.

(51) Int. Cl. C09K 3/14; B24D 3/34; B24D 3/28

(52) U.S. Cl. CPC C09K 3/1418; B24D 3/28; B24D 3/346

(57) ABSTRACT

Magnetizable agglomerate abrasive particle can comprise constituent abrasive particles retained in a binder material. The magnetizable particles and the constituent abrasive particles are unassociated, and wherein the magnetizable particles have a Mohs hardness of 6 or less. Magnetizable agglomerate abrasive particles can also comprise magnetizable abrasive particles retained in a binder material, wherein each magnetizable abrasive particle comprises a respective ceramic body and a magnetizable layer disposed on at least a portion of the ceramic body. Pluralities of abrasive particles are also disclosed. Methods of making, and abrasive articles including the magnetizable agglomerate particles are also disclosed.

### TECHNICAL FIELD

The present disclosure broadly relates to abrasive particles, abrasive articles, and methods of making them.

### BACKGROUND

Various types of abrasive articles are known in the art. For example, coated abrasive articles generally have abrasive particles adhered to a backing by a resinous binder material. Examples include sandpaper and structured abrasives having precisely shaped abrasive composites adhered to a backing. The abrasive composites generally include abrasive particles and a resinous binder.

Bonded abrasive particles include abrasive particles retained in a binder matrix that can be resinous or vitreous. Examples include, grindstones, cutoff wheels, hones, and whetstones.

Precise placement and orientation of abrasive particles in abrasive articles such as, for example, coated abrasive articles and bonded abrasive articles has been a source of continuous interest for many years.

For example, coated abrasive articles have been made using techniques such as electrostatic coating of abrasive particles have been used to align crushed abrasive particles with the longitudinal axes perpendicular to the backing. Likewise, shaped abrasive particles have been aligned by mechanical methods as disclosed in U. S. Pat. Appl. Publ. 2013/0344786 A1 (Keipert).

Precise placement and orientation of abrasive particles in bonded abrasive articles has been described in the patent literature. For example, U.S. Pat. No. 1,930,788 (Buckner) describes the use of magnetic flux to orient abrasive grain having a thin coating of iron dust in bonded abrasive articles. Likewise, British (G. B.) Pat. No. 396,231 (Buckner) describes the use of a magnetic field to orient abrasive grain having a thin coating of iron or steel dust to orient the abrasive grain in bonded abrasive articles. Using this technique, abrasive particles were radially oriented in bonded wheels.

U. S. Pat. Appl. Publ. No. 2008/0289262 A1 (Gao) discloses equipment for making abrasive particles in even distribution, array pattern, and preferred orientation. Using electric current to form a magnetic field causing acicular soft magnetic metallic sticks to absorb or release abrasive particles plated with soft magnetic materials.

Agglomerate abrasive particles are known in the abrasive arts and have been included in various abrasive articles. The terms “agglomerate” and “aggregate” as applied to abrasive particles are used more or less interchangeably, and generally all such agglomerate or aggregate abrasive particles include abrasive particles bonded to one another by a binder material. The binder material can be a vitreous inorganic binder (e.g., vitreous bond) or an organic-resin based binder.

Vitreous bond agglomerate abrasive particles have been reported in the art. For example, see U.S. Pat. No. 6,551,366 (D'Souza et al.); U.S. Pat. No. 6,521,004 (Culler et al.); U.S. Pat. No. 6,790,126 (Wood et al.); U.S. Pat. No. 6,913,824 (Culler et al.); and U.S. Pat. No. 7,887,608 (Schwabel et al.).

Similarly, vitreous bonded aggregate abrasive particles have been reported. For example, see U.S. Pat. No. 2,216,728 (Benner et al.); U.S. Pat. No. 7,399,330 (Schwabel et al.); U.S. Pat. No. 6,620,214 (McArdle et al.); and U.S. Pat. No. 6,881,483 (McArdle et al.).

Organic resin-based agglomerate abrasive particles are described in U.S. Pat. No. 4,799,939 (Bloecher et al.). In general, these agglomerate abrasive particles (also variously termed “agglomerate abrasive grain”) are formed from smaller abrasive particles (hereinafter “constituent abrasive particles”) retained in a binder material. The constituent abrasive particles are generally randomly oriented within the agglomerate abrasive particles.

### SUMMARY

In one aspect, the present disclosure provides a magnetizable agglomerate abrasive particle comprising magnetizable particles and constituent abrasive particles retained in a binder matrix, wherein the magnetizable particles and the constituent abrasive particles are unassociated, and wherein the magnetizable particles have a Mohs hardness of 6 or less.

In another aspect, the present disclosure provides a magnetizable agglomerate abrasive particle comprising magnetizable abrasive particles retained in a binder matrix, wherein each magnetizable abrasive particle comprises a respective ceramic body and a magnetizable layer disposed on at least a portion of the ceramic body.

In another aspect, the present disclosure provides a plurality of agglomerate abrasive particles according to the present disclosure.

In another aspect, the present disclosure provides an abrasive article comprising a plurality of agglomerate abrasive particles according to the present disclosure retained in a second binder material.

In yet another aspect, the present disclosure provides a method of making an agglomerate abrasive particle, the method comprising steps:

a) filling a cavity of a mold with a slurry comprising a binder precursor and magnetizable abrasive particles;

b) applying a magnetic field to orient the magnetizable abrasive particles; and

c) at least one of drying or curing the binder precursor sufficient to fix the respective orientations of the magnetizable abrasive particles.

Advantageously, according to the present disclosure it is possible to orient abrasive particles within a magnetizable agglomerate abrasive particle such that they have substantially parallel magnetic axis in the presence of an external magnetic field and optionally parallel abrasive particle orientation. Further, the resultant agglomerate abrasive particles can be placed and/or oriented in abrasive articles using an external magnetic field.

As used herein:

The term “ceramic” refers to any of various hard, brittle, heat- and corrosion-resistant materials made of at least one metallic element (which may include silicon) combined with oxygen, carbon, nitrogen, or sulfur. Ceramics may be crystalline or polycrystalline, for example.

The term “ferrimagnetic” refers to materials (in bulk) that exhibit ferrimagnetism. Ferrimagnetism is a type of permanent magnetism that occurs in solids in which the magnetic fields associated with individual atoms spontaneously align themselves, some parallel, or in the same direction (as in ferromagnetism), and others generally antiparallel, or paired off in opposite directions (as in antiferromagnetism). The magnetic behavior of single crystals of ferrimagnetic materials may be attributed to the parallel alignment; the diluting effect of those atoms in the antiparallel arrangement keeps the magnetic strength of these materials generally less than that of purely ferromagnetic solids such as metallic iron. Ferrimagnetism occurs chiefly in magnetic oxides known as ferrites. The spontaneous alignment that produces ferrimagnetism is entirely disrupted above a temperature called the Curie point, characteristic of each ferrimagnetic material. When the temperature of the material is brought below the Curie point, ferrimagnetism revives.

The term “ferromagnetic” refers to materials (in bulk) that exhibit ferromagnetism. Ferromagnetism is a physical phenomenon in which certain electrically uncharged materials strongly attract others. In contrast to other substances, ferromagnetic materials are magnetized easily, and in strong magnetic fields the magnetization approaches a definite limit called saturation. When a field is applied and then removed, the magnetization does not return to its original value. This phenomenon is referred to as hysteresis. When heated to a certain temperature called the Curie point, which is generally different for each substance, ferromagnetic materials lose their characteristic properties and cease to be magnetic; however, they become ferromagnetic again on cooling.

The terms “magnetic” and “magnetized” mean being ferromagnetic or ferrimagnetic at 20° C., or capable of being made so, unless otherwise specified. Preferably, magnetizable layers according to the present disclosure either have, or can be made to have by exposure to an applied magnetic field, a magnetic moment of at least 0.001 electromagnetic units (emu), more preferably at least 0.005 emu, more preferably 0.01 emu, up to an including 0.1 emu, although this is not a requirement.

The term “magnetic field” refers to magnetic fields that are not generated by any astronomical body or bodies (e.g., Earth or the sun). In general, applied magnetic fields used in practice of the present disclosure have a magnetic field strength in the region of the magnetizable abrasive particles being oriented of at least about 10 gauss (1 mT), preferably at least about 100 gauss (10 mT).

The term “magnetizable” means capable of being magnetized or already in a magnetized state.

The term “length” refers to the longest dimension of an object.

The term “width” refers to the longest dimension of an object that is perpendicular to its length.

The term “thickness” refers to the longest dimension of an object that is perpendicular to both of its length and width.

The term “aspect ratio” refers to the ratio length/thickness of an object.

The term “substantially” means within 35 percent (preferably within 30 percent, more preferably within 25 percent, more preferably within 20 percent, more preferably within 10 percent, and more preferably within 5 percent) of the attribute being referred to.

Features and advantages of the present disclosure will be further understood upon consideration of the detailed description as well as the appended claims.

### BRIEF DESCRIPTION OF THE DRAWINGS

FIG. 1 is a schematic perspective view of an exemplary magnetizable agglomerate abrasive particle 100 according to one embodiment of the present disclosure.

FIG. 2 is a schematic perspective view of an exemplary magnetizable agglomerate abrasive particle 200 according to one embodiment of the present disclosure.

FIG. 3A is a schematic perspective view of an exemplary magnetizable abrasive particle 210 included in magnetizable agglomerate abrasive particle 200 of FIG. 2.

FIG. 3B is a schematic cross-sectional view of the magnetizable abrasive particle 210 shown in FIG. 3A taken along line 3B-3B.

FIG. 4 is a perspective view of an exemplary bonded abrasive wheel 400 according to the present disclosure.

FIG. 5 is a side view of an exemplary coated abrasive article 500 according to the present disclosure.

FIG. 6 is a side view of an exemplary coated abrasive article 600 according to the present disclosure.

FIG. 7A is a perspective view of an exemplary nonwoven abrasive article 700 according to the present disclosure.

FIG. 7B is an enlarged view of region 7B in FIG. 7A.

FIG. 8 is a digital micrograph of magnetizable agglomerate abrasive precursor particles prepared according to Example 1.

FIG. 9 is a digital micrograph of magnetizable agglomerate abrasive particles prepared according to Example 1.

FIG. 10 is a digital micrograph of magnetizable agglomerate abrasive precursor particles prepared according to Example 2.

FIG. 11 is a digital micrograph of magnetizable agglomerate abrasive particle prepared according to Example 2.

FIG. 12 is a digital micrograph of magnetizable agglomerate abrasive precursor particles prepared according to Example 5.

FIG. 13 is a digital micrograph of magnetizable agglomerate abrasive precursor particles prepared according to Example 6.

FIG. 14 is a digital micrograph of a coated abrasive article according to Example 8.

FIG. 15 is a digital micrograph of a coated abrasive article according to Example 9.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

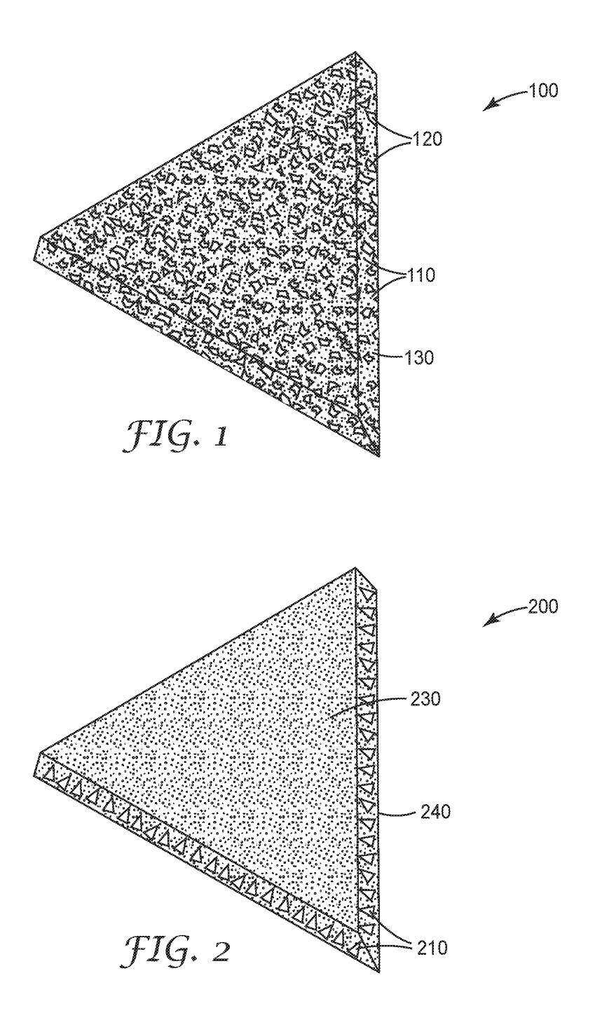

Magnetizable agglomerate abrasive particles according to the present disclosure may have at least two different basic configurations. A first configuration is shown in FIG. 1.

Referring now to FIG. 1, a magnetizable agglomerate abrasive particle 100 comprises magnetizable particles 110 and constituent abrasive particles 120 retained in a binder matrix 130 (also referred to simply as “binder”). The magnetizable particles and the constituent abrasive particles are unassociated. That is, the magnetizable particles are not bound locally to the surface of the constituent abrasive particles as a coating, but rather are distributed generally throughout the binder matrix. In this configuration, the magnetizable particles should be selected have a Mohs hardness of 6 or less (i.e., less than or equal to orthoclase feldspar).

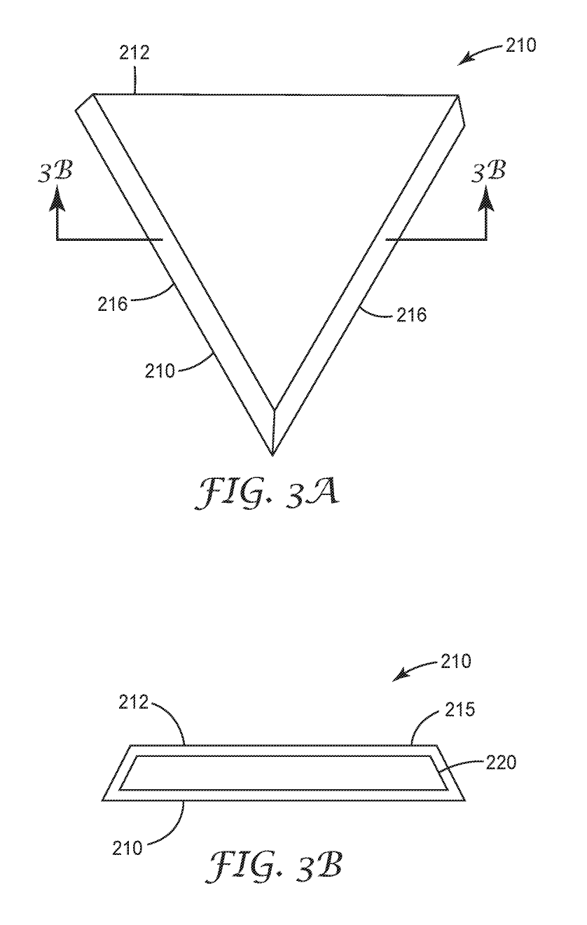

In a second configuration, shown in FIG. 2, a magnetizable agglomerate abrasive particle 200 comprises magnetizable abrasive particles 210 retained in a binder matrix 230. Referring now to FIG. 3B, each magnetizable abrasive particle 210 comprises a respective ceramic body 220 and a magnetizable layer 215 disposed on at least a portion of the ceramic body 220. Referring now to FIG. 3A, magnetizable abrasive particles 210 (shown as truncated trigonal pyramids) each have two opposed major facets 210, 212 connected to each other by a plurality of side facets 216. A majority of the magnetizable abrasive particles 210 are substantially perpendicular to a common plane 240. While FIG. 2 shows a magnetizable agglomerate abrasive particle that has a geometric shape (i.e., truncated trigonal pyramid), this type of magnetizable agglomerate abrasive particle may be globular or otherwise randomly shaped.

For embodiments involving magnetizable abrasive particles, the magnetizable layer may be a unitary magnetizable material, or it may comprise magnetizable particles in a secondary binder material. Secondary binder materials may be vitreous or organic, for example, as described for the binder matrix (130, 230) hereinbelow. This optional secondary vitreous or organic resinous binder may be, for example selected from those vitreous and organic binders listed hereinabove, for example.

The ceramic body can be any ceramic particle (preferably a ceramic abrasive particle); for example, selected from among the ceramic abrasive particles (i.e., not including diamond) of the abrasive particles listed hereinbelow. The magnetizable layer may be disposed on the ceramic body by any suitable method such as, for example, dip coating, spraying, painting, and powder coating. The magnetizable layer may be coated over the entire surface of the ceramic body, or simply a portion of it. Likewise, individual magnetizable abrasive particles may have different degrees and/or locations of coverage. The magnetizable layer is preferably essentially free of (i.e., containing less than 5 weight percent of, preferably containing less than 1 weight percent of) ceramic abrasive materials used in the shaped ceramic body.

The magnetizable layer may consist essentially of magnetizable materials (e.g., >99 to 100 percent by weight of vapor coated metals and alloys thereof), or it may contain magnetic particles retained in a binder matrix. The binder matrix of the magnetizable layer, if present, can be inorganic (e.g., vitreous) or organic resin-based, and is typically formed from a respective binder precursor.

The binder matrix of the magnetizable agglomerate abrasive particles can be inorganic (e.g., vitreous) or organic resin-based, and is typically formed from a respective binder precursor. Preferably, the binder is more friable than the constituent abrasive particles or magnetizable abrasive particles so that the binder fractures to release the corresponding abrasive particles from the binder matrix before they become smoothed or polished, thereby exposing fresh abrasive particles to a workpiece being abraded.

Vitreous binder may be produced from a precursor composition comprising a mixture or combination of one or more raw materials that when heated to a high temperature melt and/or fuse to form an integral vitreous binder matrix. The vitreous binder may be formed, for example, from frit. A frit is a composition that has been pre-fired before its use as a vitreous binder precursor composition for forming the vitreous binder of the magnetizable agglomerate abrasive particle.

As used herein, the term “frit” is a generic term for a material that is formed by thoroughly blending a mixture comprising one or more frit forming components, followed by heating (also referred to as pre-firing) the mixture to a temperature at least high enough to melt it; cooling the resulting glass, and crushing it. The crushed material can then be screened to a very fine powder.

Examples of suitable glasses for the vitreous binder and the frit for making it include silica glass, silicate glass, borosilicate glass, and combinations thereof. A silica glass is typically composed of 100 percent by weight of silica. In some embodiments, the vitreous binder is a glass that include metal oxides or oxides of metalloids, for example, aluminum oxide, silicon oxide, boron oxide, magnesium oxide, sodium oxide, manganese oxide, zinc oxide, calcium oxide, barium oxide, lithium oxide, potassium oxide, titanium oxide, metal oxides that can be characterized as pigments (e.g., cobalt oxide, chromium oxide, and iron oxide), and mixtures thereof.

Examples of suitable ranges for the vitreous binder and/or vitreous binder precursor, include, based on the total weight of the vitreous binder and/or vitreous binder precursor: 25 to 90% by weight, preferably 35 to 85% by weight of SiO₂; 0 to 40% by weight, preferably 0 to 30% by weight, of B₂O₃; 0 to 40% by weight, preferably 5 to 30% by weight, of Al₂O₃; 0 to 5% by weight, preferably 0 to 3% by weight, of Fe₂O₃; 0 to 5% by weight, preferably 0 to 3% by weight, of TiO₂; 0 to 20% by weight, preferably 0 to 10% by weight, of CaO; 0 to 20% by weight, preferably 1 to 10% by weight, of MgO; 0 to 20% by weight, preferably 0 to 10% by weight, of K₂O; 0 to 25% by weight, preferably 0 to 15% by weight, of Na₂O; 0 to 20% by weight, preferably 0 to 12% by weight, of Li₂O; 0 to 10% by weight, preferably 0 to 3% by weight, of ZnO; 0 to 10% by weight, preferably 0 to 3% by weight, of BaO; and 0 to 5% by weight, preferably 0 to 3% by weight, of metallic oxides (e.g., CoO, Cr₂O₃ or other pigments).

An example of a suitable silicate glass composition comprises about 70 to about 80 percent by weight of silica, about 10 to about 20 percent sodium oxide, about 5 to about 10 percent calcium oxide, about 0.5 to about 1 percent aluminum oxide, about 2 to about 5 percent magnesium oxide, and about 0.5 to about 1 percent potassium oxide, based on the total weight of the glass frit. Another example of a suitable silicate glass composition includes about 73 percent by weight of silica, about 16 percent by weight of sodium oxide, about 5 percent by weight of calcium oxide, about 1 percent by weight of aluminum oxide, about 4 percent by weight of magnesium oxide, and about 1 percent by weight of potassium oxide, based on the total weight of the glass frit. In some embodiments, the glass matrix comprises an alumina-borosilicate glass comprising SiO₂, B₂O₃, and Al₂O₃. An example of a suitable borosilicate glass composition comprises about 50 to about 80 percent by weight of silica, about 10 to about 30 percent by weight of boron oxide, about 1 to about 2 percent by weight of aluminum oxide, about 0 to about 10 percent by weight of magnesium oxide, about 0 to about 3 percent by weight of zinc oxide, about 0 to about 2 percent by weight of calcium oxide, about 1 to about 5 percent by weight of sodium oxide, about 0 to about 2 percent by weight of potassium oxide, and about 0 to about 2 percent by weight of lithium oxide, based on the total weight of the glass frit. Another example of a suitable borosilicate glass composition includes about 52 percent by weight of silica, about 27 percent by weight of boron oxide, about 9 percent by weight of aluminum oxide, about 8 percent by weight of magnesium oxide, about 2 percent by weight of zinc oxide, about 1 percent by weight of calcium oxide, about 1 percent by weight of sodium oxide, about 1 percent by weight of potassium oxide, and about 1 percent by weight of lithium oxide, based on the total weight of the glass frit. Other examples suitable borosilicate glass composition include, based upon weight, 47.61% SiO₂, 16.65% Al₂O₃, 0.38% Fe₂O₃, 0.35% TiO₂, 1.58% CaO, 0.10% MgO, 9.63% Na₂O, 2.86% K₂O, 1.77% Li₂O, 19.03% B₂O₃, 0.02% MnO₂, and 0.22% P₂O₅; and 63% SiO₂, 12% Al₂O₃, 1.2% CaO, 6.3% Na₂O, 7.5% K₂O, and 10% B₂O₃. In some embodiments, a useful alumina-borosilicate glass composition comprises, by weight, about 18% B₂O₃, 8.5% Al₂O₃, 2.8% BaO, 1.1% CaO, 2.1% Na₂O, 1.0% Li₂O, with the balance being SiO₂. Such an alumina-borosilicate glass, having a particle size of less than about 45 mm, is commercially available from Specialty Glass Incorporated, Oldsmar, Fla.

Glass frit for making glass-ceramics may be selected from the group consisting of magnesium aluminosilicate, lithium aluminosilicate, zinc aluminosilicate, calcium aluminosilicate, and combinations thereof. Known crystalline ceramic phases that can form glasses within the above listed systems include: cordierite (2MgO.2Al₂O₃.5SiO₂), gehlenite (2CaO.Al₂O₃.SiO₂), anorthite (2CaO.Al₂O₃.2SiO₂), hardystonite (2CaO.ZnO.2SiO₂), akeranite (2CaO.MgO.2SiO₂), spodumene (2Li₂O.Al₂O₃.4SiO₂), willemite (2ZnO.SiO₂), and gahnite (ZnO.Al₂O₃). Glass frit for making glass-ceramic may comprise nucleating agents. Nucleating agents are known to facilitate the formation of crystalline ceramic phases in glass-ceramics. As a result of specific processing techniques, glassy materials do not have the long range order that crystalline ceramics have. Glass-ceramics are the result of controlled heat-treatment to produce, in some cases, over 90% crystalline phase or phases with the remaining non-crystalline phase filling the grain boundaries. Glass ceramics combine the advantage of both ceramics and glasses and offer durable mechanical and physical properties.

Frit useful for forming vitreous binder may also contain frit binders (e.g, feldspar, borax, quartz, soda ash, zinc oxide, whiting, antimony trioxide, titanium dioxide, sodium silicofluoride, flint, cryolite, boric acid, and combinations thereof) and other minerals (e.g., clay, kaolin, wollastonite, limestone, dolomite, chalk, and combinations thereof).

Vitreous binder in the magnetizable agglomerate abrasive particles may be selected, for example, based on a desired coefficient of thermal expansion (CTE). Generally, it is useful for the vitreous binder and abrasive particles to have similar CTEs, for example, ±100%, 50%, 40%, 25%, or 20% of each other. The CTE of fused alumina is typically about 8×10⁻⁶/Kelvin (K). A vitreous binder may be selected to have a CTE in a range from 4×10⁻⁶/K to 16×10⁻⁶/K. An example of a glass frit for making a suitable vitreous binder is commercially available, for example, as F245 from Fusion Ceramics, Carrollton, Ohio.

During manufacture, the vitreous binder precursor, in a powder form, may be mixed with a temporary binder, typically an organic binder (e.g., starch, sucrose, mannitol), which burns out during firing of the vitreous binder precursor.

Organic binders (e.g., crosslinked organic polymers) are generally prepared by at least partially drying and/or curing (i.e., crosslinking) a resinous organic binder precursor. Examples of suitable organic binder precursors include thermally-curable resins and radiation-curable resins, which may be cured, for example, thermally and/or by exposure to radiation. Exemplary organic binder precursors include glues, phenolic resins, aminoplast resins, urea-formaldehyde resins, melamine-formaldehyde resins, urethane resins, acrylic resins (e.g., aminoplast resins having pendant α,β-unsaturated groups, acrylated urethanes, acrylated epoxy resins, acrylated isocyanurates), acrylic monomer/oligomer resins, epoxy resins (including bismaleimide and fluorene-modified epoxy resins), isocyanurate resins, an combinations thereof. Curatives such as thermal initiators, catalysts, photoinitiators, hardeners, and the like may be added to the organic binder precursor, typically selected and in an effective amount according to the resin system chosen.

Further details concerning of suitable organic binder precursors and their use in making agglomerate abrasive particles can be found in U.S. Pat. No. 4,652,275 (Bloecher et al.).

Firing/sintering of vitreous binders can be done, for example, in a kiln or tube furnace using techniques known in the art. Conditions for curing organic binder precursors may include heating in an oven or with infrared radiation and/or actinic radiation (e.g., in the case of photoinitiated cure) using techniques known in the art.

The constituent abrasive particles and magnetizable particles, or the magnetizable abrasive particles, are generally mixed with the binder material precursor prior to forming the magnetizable agglomerate abrasive particles, preferably as loose particles. The mixture can be shaped at this point to provide precursor shaped abrasive agglomerates, which after firing (inorganic) or curing (organic) converts the binder precursor into the binder matrix of the finished magnetizable agglomerate abrasive particle; as discussed hereinabove.

Useful constituent abrasive particles include, for example, crushed particles of fused aluminum oxide, heat treated aluminum oxide, white fused aluminum oxide, ceramic aluminum oxide materials such as those commercially available as 3M CERAMIC ABRASIVE GRAIN from 3M Company of St. Paul, Minn., black silicon carbide, green silicon carbide, titanium diboride, boron carbide, tungsten carbide, titanium carbide, diamond, cubic boron nitride, garnet, fused alumina zirconia, (e.g., alumina ceramics doped with chromia, ceria, zirconia, titania, silica, and/or tin oxide), silicates, tin oxide, silica (such as quartz, glass beads, glass bubbles and glass fibers), silicates (e.g., talc, clays (e.g., montmorillonite), feldspar, mica, calcium silicate, calcium metasilicate, sodium aluminosilicate, sodium silicate), flint, or emery. Examples of sol-gel derived crushed ceramic particles can be found in U.S. Pat. No. 4,314,827 (Leitheiser et al.), U.S. Pat. No. 4,623,364 (Cottringer et al.); U.S. Pat. No. 4,744,802 (Schwabel), U.S. Pat. No. 4,770,671 (Monroe et al.); and U.S. Pat. No. 4,881,951 (Monroe et al.).

Further details concerning methods of making sol-gel-derived ceramic particles can be found in, for example, U.S. Pat. No. 4,314,827 (Leitheiser), U.S. Pat. No. 5,152,917 (Pieper et al.), U.S. Pat. No. 5,213,591 (Celikkaya et al.), U.S. Pat. No. 5,435,816 (Spurgeon et al.), U.S. Pat. No. 5,672,097 (Hoopman et al.), U.S. Pat. No. 5,946,991 (Hoopman et al.), U.S. Pat. No. 5,975,987 (Hoopman et al.), and U.S. Pat. No. 6,129,540 (Hoopman et al.), and in U. S. Publ. Pat. Appln. Nos. 2009/0165394 A1 (Culler et al.) and 2009/0169816 A1 (Erickson et al.).

The constituent abrasive particles may be shaped (i.e., having a nonrandom shape imparted by the method of their manufacture). For example, shaped abrasive particles may be prepared by a molding process using sol-gel technology as described in U.S. Pat. No. 5,201,916 (Berg); U.S. Pat. No. 5,366,523 (Rowenhorst (Re 35,570)); and U.S. Pat. No. 5,984,988 (Berg). U.S. Pat. No. 8,034,137 (Erickson et al.) describes alumina abrasive particles that have been formed in a specific shape, then crushed to form shards that retain a portion of their original shape features. In some embodiments, shaped alpha alumina particles are precisely-shaped (i.e., the particles have shapes that are at least partially determined by the shapes of cavities in a production tool used to make them).

Details concerning such abrasive particles and methods for their preparation can be found, for example, in U.S. Pat. No. 8,142,531 (Adefris et al.); U.S. Pat. No. 8,142,891 (Culler et al.); and U.S. Pat. No. 8,142,532 (Erickson et al.); and in U. S. Pat. Appl. Publ. Nos. 2012/0227333 (Adefris et al.); 2013/0040537 (Schwabel et al.); and 2013/0125477 (Adefris).

Exemplary useful magnetizable materials may comprise: iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (typically about 85:9:6 by weight) marketed as Sendust alloy; Heusler alloys (e.g., Cu₂MnSn); manganese bismuthide (also known as Bismanol); rare earth magnetizable materials such as gadolinium, dysprosium, holmium, europium oxide, alloys of neodymium, iron and boron (e.g., Nd₂Fe₁₄B), and alloys of samarium and cobalt (e.g., SmCo₅); MnSb; MnOFe₂O₃; Y₃Fe₅O₁₂; CrO₂; MnAs; ferrites such as ferrite, magnetite, zinc ferrite; nickel ferrite; cobalt ferrite, magnesium ferrite, barium ferrite, and strontium ferrite; yttrium iron garnet; and combinations of the foregoing. In some preferred embodiments, the magnetizable material comprises at least one metal selected from iron, nickel, and cobalt, an alloy of two or more such metals, or an alloy of at one such metal with at least one element selected from phosphorus and manganese. In some preferred embodiments, the magnetizable material is an alloy containing 8 to 12 weight percent (wt. %) aluminum, 15 to 26 wt. % nickel, 5 to 24 wt. % cobalt, up to 6 wt. % copper, up to 1 1. % titanium, wherein the balance of material to add up to 100 wt. % is iron.

The magnetizable particles may have any size capable of physically fitting within a magnetizable agglomerate abrasive particle, but are preferably much smaller than the magnetizable agglomerate abrasive particle (e.g., as in FIG. 1) as judged by average particle diameter, preferably 4 to 2000 times smaller, more preferably 100 to 2000 times smaller, and even more preferably 500 to 2000 times smaller, although other sizes may also be used. In this embodiment, the magnetizable particles may have a Mohs hardness of 6 or less (e.g., 5 or less, or 4 or less), although this is not a requirement.

In some embodiments, the magnetizable layer may be deposited using a vapor deposition technique such as, for example, physical vapor deposition (PVD) including magnetron sputtering. PVD metallization of various particles is disclosed in, for example, U.S. Pat. No. 4,612,242 (Vesley) and U.S. Pat. No. 7,727,931 (Brey et al.). Metallic magnetizable layers can typically be prepared in this general manner.

Examples of metallic materials that may be vapor coated include stainless steels, nickel, cobalt, Exemplary useful magnetizable particles/materials may comprise: iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (typically about 85:9:6 by weight) marketed as Sendust alloy; Heusler alloys (e.g., Cu₂MnSn); manganese bismuthide (also known as Bismanol); rare earth magnetizable materials such as gadolinium, dysprosium, holmium, europium oxide, and alloys of samarium and cobalt (e.g., SmCo₅); MnSb; ferrites such as ferrite, magnetite, zinc ferrite; nickel ferrite; cobalt ferrite, magnesium ferrite, barium ferrite, and strontium ferrite; and combinations of the foregoing. In some preferred embodiments, the magnetizable material comprises at least one metal selected from iron, nickel, and cobalt, an alloy of two or more such metals, or an alloy of at one such metal with at least one element selected from phosphorus and manganese. In some preferred embodiments, the magnetizable material is an alloy containing 8 to 12 weight percent (wt. %) aluminum, 15 to 26 wt. % nickel, 5 to 24 wt. % cobalt, up to 6 wt. % copper, up to 1 wt. % titanium, wherein the balance of material to add up to 100 wt. % is iron.

In some embodiments of the type shown in FIG. 2, the magnetizable layer preferably comprises a unitary layer comprising magnetizable materials (e.g., those magnetizable materials described for use as the magnetizable particles above) retained in a binder and disposed on a ceramic body, although this is not a requirement. The magnetizable layer may comprise the magnetizable particles discussed above, except that smaller particle sizes will typically be more desirable.

Magnetizable agglomerate abrasive particles according to the present disclosure may be independently sized according to an abrasives industry recognized specified nominal grade. Exemplary abrasive industry recognized grading standards include those promulgated by ANSI (American National Standards Institute), FEPA (Federation of European Producers of Abrasives), and JIS (Japanese Industrial Standard). ANSI grade designations (i.e., specified nominal grades) include, for example: ANSI 4, ANSI 6, ANSI 8, ANSI 16, ANSI 24, ANSI 36, ANSI 46, ANSI 54, ANSI 60, ANSI 70, ANSI 80, ANSI 90, ANSI 100, ANSI 120, ANSI 150, ANSI 180, ANSI 220, ANSI 240, ANSI 280, ANSI 320, ANSI 360, ANSI 400, and ANSI 600. FEPA grade designations include F4, F5, F6, F7, F8, F10, F12, F14, F16, F18, F20, F22, F24, F30, F36, F40, F46, F54, F60, F70, F80, F90, F100, F120, F150, F180, F220, F230, F240, F280, F320, F360, F400, F500, F600, F800, F1000, F1200, F1500, and F2000. JIS grade designations include 1158, 11512, 11516, JIS24, JIS36, JIS46, JIS54, 11560, 11580, JIS100, JIS150, JIS180, JIS220, JIS240, JIS280, JIS320, JIS360, 115400, 115600, 115800, JIS1000, JIS1500, JIS2500, 1154000, 1156000, 1158000, and JIS10,000.

Alternatively, the magnetizable agglomerate abrasive particles can be graded to a nominal screened grade using U.S.A. Standard Test Sieves conforming to ASTM E-11 “Standard Specification for Wire Cloth and Sieves for Testing Purposes”. ASTM E-11 prescribes the requirements for the design and construction of testing sieves using a medium of woven wire cloth mounted in a frame for the classification of materials according to a designated particle size. A typical designation may be represented as −18+20 meaning that the crushed abrasive particles pass through a test sieve meeting ASTM E-11 specifications for the number 18 sieve and are retained on a test sieve meeting ASTM E-11 specifications for the number 20 sieve. In one embodiment, the crushed abrasive particles have a particle size such that most of the particles pass through an 18 mesh test sieve and can be retained on a 20, 25, 30, 35, 40, 45, or 50 mesh test sieve. In various embodiments, the crushed abrasive particles can have a nominal screened grade of: −18+20, −20/+25, −25+30, −30+35, −35+40, −40+45, −45+50, −50+60, −60+70, −70/+80, −80+100, −100+120, −120+140, −140+170, −170+200, −200+230, −230+270, −270+325, −325+400, −400+450, −450+500, or −500+635. Alternatively, a custom mesh size can be used such as −90+100.

Magnetizable agglomerate abrasive particles can be prepared generally according to known procedures for preparing agglomerate abrasive particles, with adjustments made for the magnetizable components. For example, the method may comprise the steps:

a) filling a cavity of a mold with a slurry comprising a binder precursor and magnetizable abrasive particles;

b) optionally applying a magnetic field to orient the magnetizable abrasive particles; and

c) curing the binder precursor to fix the respective orientations of the magnetizable abrasive particles.

In some embodiments, steps b) and c) are sequential (and optionally consecutive). In some embodiments, steps b) and c) are simultaneous.

The slurry comprises a liquid vehicle and can be made by simple mixing of the slurry components, for example. Exemplary liquid vehicles include water, alcohols (e.g., methanol, ethanol, propanol, butanol, ethylene glycol monomethyl ether), ethers (e.g., glyme, diglyme), and combinations thereof. The slurry may contain additional components such as, for example, dispersant, surfactant, mold release agent, colorant, defoamer, and rheology modifier.

If no magnetic field is applied in step b), then the resultant magnetizable agglomerate abrasive particles may not have a magnetic moment, and the constituent abrasive particles, or magnetizable abrasive particles may be randomly oriented. However, if the optional magnetic field is present then orientation of magnetizable components of the magnetizable agglomerate abrasive particles will tend to align with the magnetic field. Preferably, a majority or even all of the magnetizable agglomerate abrasive particles will have magnetic moments that are aligned substantially parallel to one another.

The optionally applied magnetic field can be supplied by any external magnet (e.g., a permanent magnet or an electromagnet). Preferably, the magnetic field is substantially uniform on the scale of individual magnetizable agglomerate abrasive particles.

For production of abrasive articles, a magnetic field can optionally be used to place and/or orient the magnetizable agglomerate abrasive particles prior to curing the binder (e.g., vitreous or organic) precursor to produce the abrasive article. The magnetic field may be substantially uniform over the magnetizable agglomerate abrasive particles before they are fixed in position in the binder or continuous over the entire, or it may be uneven, or even effectively separated into discrete sections. Typically, the orientation of the magnetic field is configured to achieve alignment of the magnetizable agglomerate abrasive particles according to a predetermined orientation.

Examples of magnetic field configurations and apparatuses for generating them are described in U. S. Pat. Appln. Publ. No. 2008/0289262 A1 (Gao) and U.S. Pat. No. 2,370,636 (Carlton), U.S. Pat. No. 2,857,879 (Johnson), U.S. Pat. No. 3,625,666 (James), U.S. Pat. No. 4,008,055 (Phaal), U.S. Pat. No. 5,181,939 (Neff), and British (G. B.) Pat. No. 1 477 767 (Edenville Engineering Works Limited).

In some embodiments, magnetic field may be used to urge the magnetizable agglomerate abrasive particles onto the make layer precursor (i.e., the binder precursor for the make layer) of a coated abrasive article while maintaining a vertical or inclined orientation relative to a horizontal backing. After at least partially curing the make layer precursor, the magnetizable agglomerate abrasive particles are fixed in their placement and orientation. Alternatively or in addition, the presence or absence of strong magnetic field can be used to selectively placed the magnetizable agglomerate abrasive particles onto the make layer precursor. An analogous process may be used for manufacture of slurry coated abrasive articles, except that the magnetic field acts on the magnetizable particles within the slurry. The above processes may also be carried out on nonwoven backings to make nonwoven abrasive articles,

Likewise, in the case of bonded abrasive article the magnetizable agglomerate abrasive particles can be positioned and/or orientated within the corresponding binder precursor, which is then pressed and cured.

Magnetizable agglomerate abrasive particles can be used in loose form (e.g., free-flowing or in a slurry) or they may be incorporated into various abrasive articles (e.g., coated abrasive articles, bonded abrasive articles, nonwoven abrasive articles, and/or abrasive brushes).

Magnetizable agglomerate abrasive particles are useful, for example, in the construction of abrasive articles, including for example, coated abrasive articles (for example, conventional make and size coated abrasive articles, slurry coated abrasive articles, and structured abrasive articles), abrasive brushes, nonwoven abrasive articles, and bonded abrasive articles such as grinding wheels, hones and whetstones.

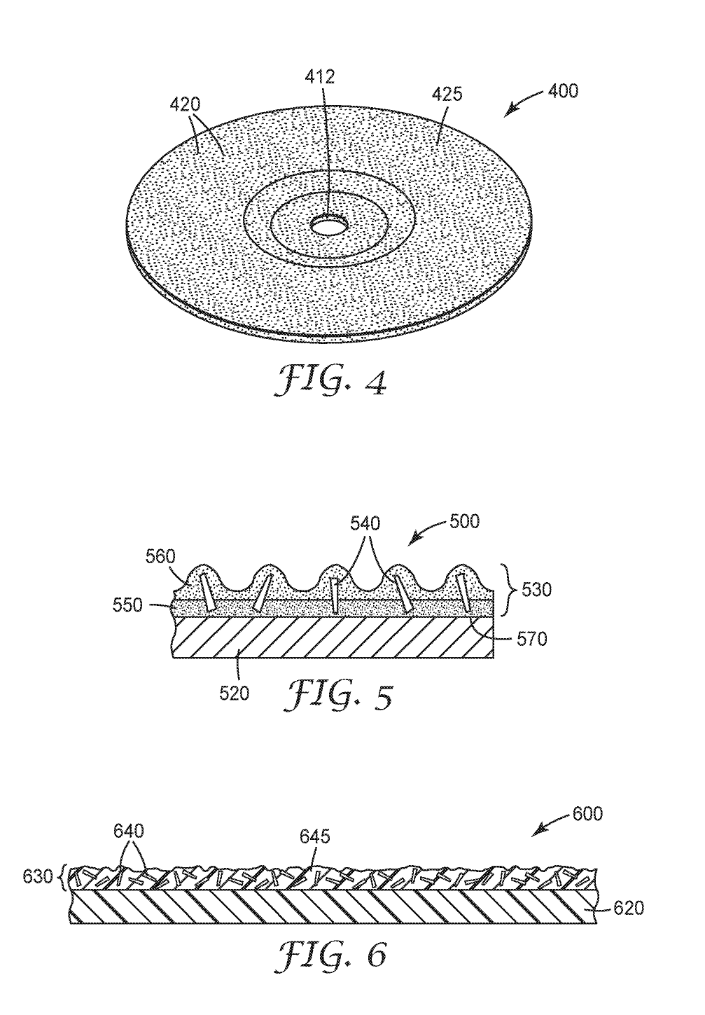

For example, FIG. 4 shows an exemplary embodiment of a Type 27 depressed-center grinding wheel 400 (i.e., an embodiment of a bonded abrasive article) according to one embodiment of the present disclosure. Center hole 412 is used for attaching Type 27 depressed-center grinding wheel 400 to, for example, a power driven tool. Type 27 depressed-center grinding wheel 400 comprises magnetizable agglomerate abrasive particles 420 according to the present disclosure retained in binder 425. Examples of suitable binders 425 include: organic binders such as epoxy binders, phenolic binders, aminoplast binders, and acrylic binders; and inorganic binders such as vitreous binders.

Further details concerning the manufacture of bonded abrasive articles according to the present disclosure can be found in, for example, U.S. Pat. No. 4,800,685 (Haynes et al.); U.S. Pat. No. 4,898,597 (Hay et al.); U.S. Pat. No. 4,933,373 (Moren); and U.S. Pat. No. 5,282,875 (Wood et al.).

In one exemplary embodiment of a coated abrasive article, the abrasive coat may comprise a make coat, a size coat, and magnetizable agglomerate abrasive particles. Referring to FIG. 5, exemplary coated abrasive article 500 has backing 520 and abrasive layer 530. Abrasive layer 530, includes magnetizable agglomerate abrasive particles 540 according to the present disclosure secured to surface 570 of backing 520 by make layer 550 and size layer 560, each comprising a respective binder (e.g., epoxy resin, urethane resin, phenolic resin, aminoplast resin, or acrylic resin) that may be the same or different.

In another exemplary embodiment of a coated abrasive article, the abrasive coat may comprise a cured slurry comprising a curable binder precursor and magnetizable agglomerate abrasive particles according to the present disclosure. Referring to FIG. 6, exemplary coated abrasive article 600 has backing 620 and abrasive layer 630. Abrasive layer 630 includes magnetizable agglomerate abrasive particles 640 and a binder 645 (e.g., epoxy resin, urethane resin, phenolic resin, aminoplast resin, acrylic resin).

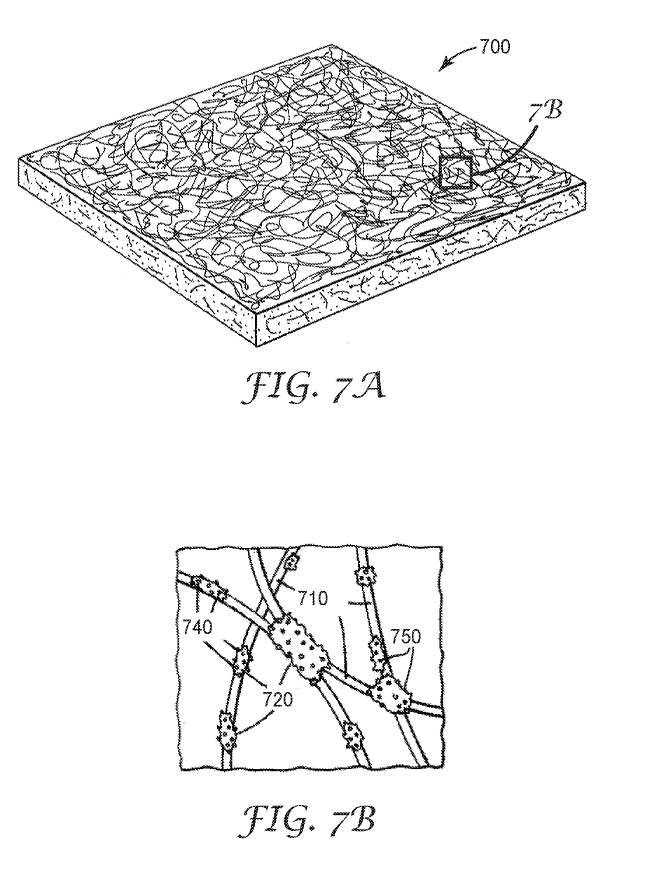

Further details concerning the manufacture of coated abrasive articles according to the present disclosure can be found in, for example, U.S. Pat. No. 4,314,827 (Leitheiser et al.), U.S. Pat. No. 4,652,275 (Bloecher et al.), U.S. Pat. No. 4,734,104 (Broberg), U.S. Pat. No. 4,751,137 (Tumey et al.), U.S. Pat. No. 5,137,542 (Buchanan et al.), U.S. Pat. No. 5,152,917 (Pieper et al.), U.S. Pat. No. 5,417,726 (Stout et al.), U.S. Pat. No. 5,573,619 (Benedict et al.), U.S. Pat. No. 5,942,015 (Culler et al.), and U.S. Pat. No. 6,261,682 (Law). Nonwoven abrasive articles typically include a porous (e.g., a lofty open porous) polymer filament structure having magnetizable agglomerate abrasive particles bonded thereto by a binder. An exemplary embodiment of a nonwoven abrasive article 700 according to the present invention is shown in FIGS. 7A and 7B. Nonwoven abrasive article 700 includes a lofty open low-density fibrous web formed of entangled filaments 710 impregnated with binder 720 (e.g., epoxy resin, urethane resin, phenolic resin, aminoplast resin, acrylic resin). Magnetizable agglomerate abrasive particles 740 according to the present disclosure are dispersed throughout fibrous web 700 on exposed surfaces of filaments 710. Binder 720 coats portions of filaments 710 and forms globules 750, which may encircle individual filaments or bundles of filaments that adhere to the surface of the filament and/or collect at the intersection of contacting filaments, providing abrasive sites throughout the nonwoven abrasive article.

Further details concerning the manufacture of nonwoven abrasive articles according to the present disclosure can be found in, for example, U.S. Pat. No. 2,958,593 (Hoover et al.), U.S. Pat. No. 4,018,575 (Davis et al.), U.S. Pat. No. 4,227,350 (Fitzer), U.S. Pat. No. 4,331,453 (Dau et al.), U.S. Pat. No. 4,609,380 (Barnett et al.), U.S. Pat. No. 4,991,362 (Heyer et al.), U.S. Pat. No. 5,554,068 (Can et al.), U.S. Pat. No. 5,712,210 (Windisch et al.), U.S. Pat. No. 5,591,239 (Edblom et al.), U.S. Pat. No. 5,681,361 (Sanders), U.S. Pat. No. 5,858,140 (Berger et al.), U.S. Pat. No. 5,928,070 (Lux), U.S. Pat. No. 6,017,831 (Beardsley et al.), U.S. Pat. No. 6,207,246 (Moren et al.), and U.S. Pat. No. 6,302,930 (Lux).

Abrasive articles according to the present disclosure are useful for abrading a workpiece. Methods of abrading range from snagging (i.e., high pressure high stock removal) to polishing (e.g., polishing medical implants with coated abrasive belts), wherein the latter is typically done with finer grades of abrasive particles. One such method includes the step of frictionally contacting an abrasive article (e.g., a coated abrasive article, a nonwoven abrasive article, or a bonded abrasive article) with a surface of the workpiece, and moving at least one of the abrasive article or the workpiece relative to the other to abrade at least a portion of the surface.

Examples of workpiece materials include metal, metal alloys, exotic metal alloys, ceramics, glass, wood, wood-like materials, composites, painted surfaces, plastics, reinforced plastics, stone, and/or combinations thereof. The workpiece may be flat or have a shape or contour associated with it. Exemplary workpieces include metal components, plastic components, particleboard, camshafts, crankshafts, furniture, and turbine blades. The applied force during abrading typically ranges from about 1 kilogram to about 100 kilograms.

Abrasive articles according to the present disclosure may be used by hand and/or used in combination with a machine. At least one of the abrasive article and the workpiece is moved relative to the other when abrading. Abrading may be conducted under wet or dry conditions. Exemplary liquids for wet abrading include water, water containing conventional rust inhibiting compounds, lubricant, oil, soap, and cutting fluid. The liquid may also contain defoamers, degreasers, for example.

### Select Embodiments of the Present Disclosure

In a first embodiment, the present disclosure provides a magnetizable agglomerate abrasive particle comprising magnetizable particles and constituent abrasive particles retained in a binder material, wherein the magnetizable particles and the constituent abrasive particles are unassociated, and wherein the magnetizable particles have a Mohs hardness of 6 or less.

In a second embodiment, the present disclosure provides a magnetizable agglomerate abrasive particle according to the first embodiment, wherein the binder matrix comprises a vitreous binder material.

In a third embodiment, the present disclosure provides a magnetizable agglomerate abrasive particle comprising magnetizable abrasive particles retained in a binder material, wherein each magnetizable abrasive particle comprises a respective ceramic body and a magnetizable layer disposed on at least a portion of the ceramic body.

In a fourth embodiment, the present disclosure provides a magnetizable agglomerate abrasive particle according to the third embodiment, wherein the magnetizable abrasive particles each have two opposed major facets connected to each other by a plurality of side facets, and wherein a majority of the magnetizable abrasive particles have at least one of the major facets aligned substantially perpendicular to a common plane.

In a fifth embodiment, the present disclosure provides a magnetizable agglomerate abrasive particle according to the third embodiment, wherein the magnetizable abrasive particles each comprise a rod having a respective longitudinal axis, and wherein a majority of the longitudinal axes are substantially parallel to each other.

In a sixth embodiment, the present disclosure provides a magnetizable agglomerate abrasive particle according to any one of the first to fifth embodiments, wherein the abrasive particles comprise shaped abrasive particles.

In a seventh embodiment, the present disclosure provides a magnetizable agglomerate abrasive particle according to any one of the first to sixth embodiments, wherein the binder matrix is vitreous.

In an eighth embodiment, the present disclosure provides a magnetizable agglomerate abrasive particle according to any one of the first to sixth embodiments, wherein the binder matrix comprises crosslinked organic polymer.

In a ninth embodiment, the present disclosure provides a plurality of agglomerate abrasive particles according to any one of the first to eighth embodiments.

In a tenth embodiment, the present disclosure provides an abrasive article comprising a plurality of agglomerate abrasive particles according to any one of the first to eighth embodiments retained in a second binder material.

In an eleventh embodiment, the present disclosure provides an abrasive article according to the tenth embodiment, wherein the abrasive article comprises a bonded abrasive wheel.

In a twelfth embodiment, the present disclosure provides an abrasive article according to the tenth embodiment, wherein the abrasive article comprises a coated abrasive article, wherein the coated abrasive article comprises an abrasive layer disposed on a backing, and wherein the abrasive layer comprises the second binder matrix and the plurality of agglomerate abrasive particles.

In a thirteenth embodiment, the present disclosure provides an abrasive article according to the twelfth embodiment, wherein the abrasive layer comprises make and size layers.

In a fourteenth embodiment, the present disclosure provides an abrasive article according to the tenth embodiment, wherein the abrasive article comprises a nonwoven abrasive, wherein the nonwoven abrasive comprises a nonwoven fiber web having an abrasive layer disposed on at least a portion thereof, and wherein the abrasive layer comprises the second binder matrix and the plurality of agglomerate abrasive particles.

In a fifteenth embodiment, the present disclosure provides a method of making an agglomerate abrasive particle, the method comprising steps:

a) filling a cavity of a mold with a slurry comprising a binder precursor and magnetizable abrasive particles;

b) applying a magnetic field to orient the magnetizable abrasive particles; and

c) at least one of drying or curing the binder precursor sufficient to fix the respective orientations of the magnetizable abrasive particles.

In a sixteenth embodiment, the present disclosure provides a method of making a magnetizable agglomerate abrasive particle according to the fifteenth embodiment, wherein steps b) and c) are sequential.

In a seventeenth embodiment, the present disclosure provides a method of making a magnetizable agglomerate abrasive particle according to the fifteenth embodiment, wherein steps b) and c) are simultaneous.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Unless stated otherwise, all other reagents were obtained, or are available from fine chemical vendors such as Sigma-Aldrich Company, St. Louis, Mo., or may be synthesized by known methods.

Materials used in the Examples are described in Table 1, below.

TABLE 1

| ABBREVIATION | DESCRIPTION |
|---|---|
| AER | Wetting agent, obtained as AEROSOL AY-100 |
| | from Cytec Industries, Inc., Woodland Park, New |
| | Jersey |
| AF | Antifoam additive, obtained as 62 ADDITIVE from |
| | Dow Corning, Midland, Michigan |
| DEX | Dextrin, obtained as STADEX 201 from Tate & |
| | Lyle, London, United Kingdom |
| MCL | Methylcellulose, obtained as METHOCEL K4M |
| | from Dow Chemical Company, Midland, Michigan |
| MP | Magnetic metal powder Sendust, obtained as SP-3B |
| | from Mate Company, Okayama, Japan |
| PR | phenolic resin, obtained as GP 8339 R-23155B from |
| | Georgia Pacific Chemicals, Atlanta, Georgia |
| SAP | Shaped abrasive particles were prepared according |
| | to the disclosure of U.S. Pat. No. 8,142,531 (Adefris |
| | et al). The shaped abrasive particles were prepared |
| | by molding alumina sol gel in equilateral triangle- |
| | shaped polypropylene mold cavities. After drying |
| | and firing, the resulting shaped abrasive particles |
| | were about 0.20 mm (side length) × 0.05 mm thick, |
| | with a draft angle approximately 98 degrees. |
| SIL | Hydrophilic fumed silica, obtained as AEROSIL |
| | OX-50 from Evonik Industries, Essen, Germany |
| V601 | A glass frit blend |

### Preparation of Magnetizable Abrasive Particles

SAP was coated with 304 stainless steel using physical vapor deposition with magnetron sputtering. 304 Stainless steel sputter target, described by Barbee et al. in Thin Solid Films, 1979, vol. 63, pp. 143-150, deposited as the magnetic ferritic body centered cubic form. The apparatus used for the preparation of 304 stainless steel film coated abrasive particles (i.e., magnetizable abrasive particles) was disclosed in U.S. Pat. No. 8,698,394 (McCutcheon et al.). The physical vapor deposition was carried out for 7 hours at 7 kilowatt at an argon sputtering gas pressure of 10 millitorr (1.33 pascal) onto 4500 grams of SAP. The density of the coated SAP was 3.944 grams per cubic centimeter (the density of the uncoated SAP was 3.914 grams per cubic centimeter). The weight percentage of metal coating in the coated abrasive particles was 0.75% and the coating thickness is 85 nanometers.

### Example 1

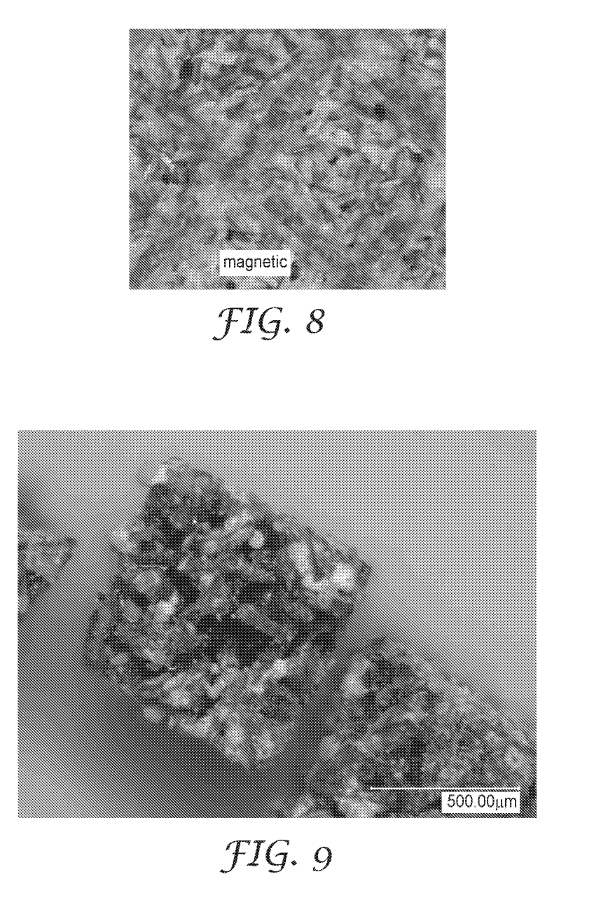

A slurry of 500 grams was prepared by mixing the components listed in Table 2 using a high-shear mixer. The resultant slurry was coated into a polypropylene mold with cavities having square openings approximately 0.87 mm long and wide and square bases approximately 0.65 mm long and wide; the depth of these cavities were 0.77 mm. The slurry was filled into the tooling while sitting on the face of a 6-inch (15.2-cm) diameter by 2-inch (5.1-cm) thick permanent neodymium magnet with an average magnetic field of 0.6 Tesla. The sample was allowed to dry at 23° C. for 30 minutes. The dried sample had 95-100% of the magnetizable agglomerate abrasive precursor particles standing upright as shown in FIG. 8.

TABLE 2

| COMPOSITION | WEIGHT PERCENT |
|---|---|
| AER | 1.54 |
| AF | 0.51 |
| DEX | 2.06 |
| MCL | 0.51 |
| SIL | 1.61 |
| V601 | 13.21 |
| Coated SAP | 51.41 |
| Water | 29.15 |

The dried shaped agglomerates were released from the tooling using an ultrasonic horn, and subsequently mixed with fine grade alumina powder (obtained as P172 from Alteo Alumina, Gardanne, France), before being sintered at higher temperatures (the conditions were programmed as in Table 3) in a refractory sager in a box kiln.

TABLE 3

| | HEATING RAMP, | TEMPERATURE, | DWELL, |
|---|---|---|---|
| SEGMENT | ° C. /minute | ° C. | hrs |
| 1 | 2.0 | 420 | 2 |
| 2 | 2.0 | 700 | 0.5 |
| 3 | 3.0 | 880 | 4 |

After sintering, the refractory sager were allowed to cool naturally to near 23° C. A picture of a magnetizable agglomerate abrasive particle after sintering is shown in FIG. 9. The agglomerates were then screened using U.S.A. Standard Test Sieves −18+25.

The resulting magnetizable agglomerate abrasive particles were responsive when positioned in the magnetic field of a permanent neodymium magnet.

### Example 2

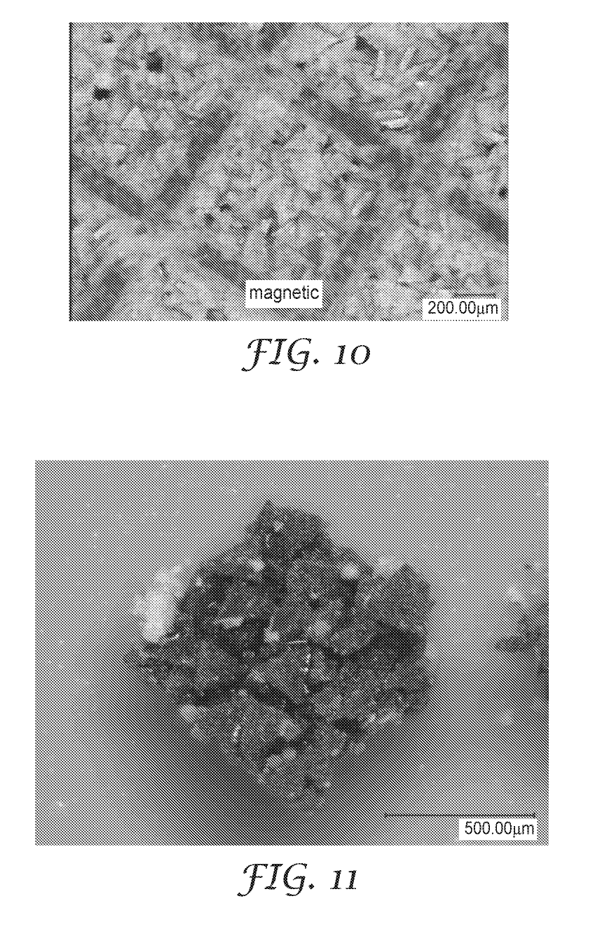

The procedure described above in EXAMPLE 1 was repeated, except that the slurry was filled into the tooling without ever being subjected to the magnetic field. The precursor abrasive particles in the dried sample had a random orientation distribution as shown in optical microscope picture FIG. 10. A picture of the magnetizable agglomerate abrasive particle after removal from the tooling and sintering is shown in FIG. 11. The resulting magnetizable agglomerate abrasive particles were responsive when positioned in the magnetic field of a permanent neodymium magnet.

### Comparative Example A

The procedure described above in EXAMPLE 1 was repeated, except that uncoated SAP was used in the slurry composition instead of coated SAP, and the slurry was filled into the tooling without ever being subjected to the magnetic field.

The resulting agglomerate abrasive particles were not responsive when positioned in the magnetic field of a permanent neodymium magnet.

### Example 3

A precut vulcanized fiber disc blank with a diameter of 7 inches (17.8 cm), having a center hole of ⅞ inch (2.2 cm) diameter and a thickness of 0.83 mm (33 mils) obtained as DYNOS VULCANIZED FIBRE from DYNOS GmbH, Troisdorf, Germany was coated with 269.9 g/m² of a phenolic make resin consisting of 49.2 parts of PR, 40.6 parts of calcium metasilicate (obtained as WOLLASTOCOAT from NYCO Company, Willsboro, N.Y.), and 10.2 parts of water. A brush was used to apply the resin. Agglomerates prepared in Example 1 were applied to the make resin-coated backing by electrostatic coating. The coating weight of agglomerates prepared in Example 1 was 622.6 g/m² over the sample. The abrasive coated backing was placed in an oven at 65.5° C. for 15 minutes and then at 98.9° C. for 65 minutes to partially cure the make resin. A size resin consisting of 29.4 parts of PR, 18.1 parts of water, 50.7 parts of cryolite (Solvay Fluorides, LLC, Houston, Tex.), and 1.8 parts red iron oxide was applied to each strip of backing material at a basis weight of 622.6 g/m², and the coated strip was placed in an oven at 87.8° C. for 100 minutes, followed by 12 hours at 102.8° C. After cure, the strip of coated abrasive was converted into a belt as is known in the art.

### Example 4

The procedure generally described in EXAMPLE 3 was repeated, except that agglomerate abrasive particles prepared in EXAMPLE 2 were used instead of agglomerates prepared in EXAMPLE 1.

### Comparative Example B

The procedure generally described in EXAMPLE 3 was repeated, except that agglomerate abrasive particles prepared in COMPARATIVE EXAMPLE A were used instead of agglomerates prepared in EXAMPLE 1.

### Performance Test

A 2 inch (5.08 cm) diameter coated abrasive disc was made from each of the samples by die-cutting the final cured belt. A ROLOC (type TR) quick change attachment from 3M Company and described generally in the disclosure of U.S. Pat. No. 6,817,935 (Bates et al.) was affixed to the center back of the disc using adhesive (obtained as LOCTITE 406 from Henkel Corporation, Westlake, Ohio). The disc to be tested was mounted on an electric rotary tool that was disposed over an X-Y table having a 1018 steel bar measuring 2 inches×18 inches×0.5 inch (50.8 mm×457.2 mm×12.7 mm) secured to the X-Y table. The tool was set to traverse at a rate of 6 inches/second (152.4 mm/sec) in the X direction along the length of the bar. The rotary tool was then activated to rotate at 7500 rounds per minute under no load. A stream of tap water was directed onto the bar on the surface to be ground, under the disc. The abrasive article was then urged at an angle of 5 degrees against the bar at a load of 9 pounds (4.08 kilograms). The tool was then activated to move along the length of the bar. The tool was then raised, and returned to the opposite end of the bar. Ten such grinding-and-return passes along the length of the bar were completed in each cycle. The mass of the panel was measured before and after each cycle to determine the total mass loss in grams after each cycle. The test was considered finished when the cut of the disc dropped below 3 grams in any given cycle. A total cut was determined as cumulative mass loss was at the end of the test. The disc was weighed before and after the completion of the test to determine the wear. The G-ratio was calculated as the total cut in grams divided by disc weight loss in grams. Results are reported in Table 4, below.

TABLE 4

| | CUT, grams | | |
|---|---|---|---|
| | | | Comparative |
| CYCLE | Example 3 | Example 4 | Example B |
| 1 | 6.77 | 8.44 | 8.07 |
| 2 | 6.06 | 7.03 | 7.10 |
| 3 | 6.06 | 6.11 | 6.17 |
| 4 | 5.94 | 5.33 | 5.44 |
| 5 | 5.59 | 4.74 | 4.47 |
| 6 | 5.57 | 4.28 | 4.10 |
| 7 | 5.75 | 4.64 | 3.93 |
| 8 | 5.05 | 3.95 | 3.60 |
| 9 | 4.56 | 3.64 | 2.89 |
| 10 | 4.46 | 2.98 | — |
| 11 | 4.16 | — | — |
| 12 | 4.12 | — | — |
| 13 | 3.85 | — | — |
| 14 | 3.17 | — | — |
| 15 | 3.35 | — | — |
| 16 | 3.25 | — | — |
| 17 | 3.12 | — | — |
| 18 | 3.19 | — | — |
| 19 | 2.78 | — | — |
| Total cut, grams | 86.80 | 51.14 | 45.77 |
| Disc weight loss, | 1.71 | 2.11 | 1.64 |
| grams | | | |
| G-Ratio | 50.8 | 24.2 | 27.9 |

### Example 5

A slurry of 500 grams was prepared by mixing the components listed in Table 5 using a high-shear mixer. The resultant slurry was coated into a polypropylene mold with cavities having square openings approximately 0.87 mm long and wide and square bases approximately 0.65 mm long and wide; the depth of these cavities were 0.77 mm. The slurry was filled into the tooling while sitting on the face of a 6-inch (15.2-cm) diameter by 2-inch (5.1-cm) thick permanent neodymium magnet with an average magnetic field of 0.6 Tesla. The dried sample had 95-100% of the magnetizable agglomerate abrasive precursor particles standing upright as shown in FIG. 12. The sample was cured at 76.7° C. for 24 hours.

The cured shaped agglomerates were released from the tooling using an ultrasonic horn.

TABLE 5

| COMPOSITION | WEIGHT PERCENT |
|---|---|
| PR | 17.5% |
| Isopropyl Alcohol | 5.5% |
| Coated SAP | 77.0% |

### Example 6

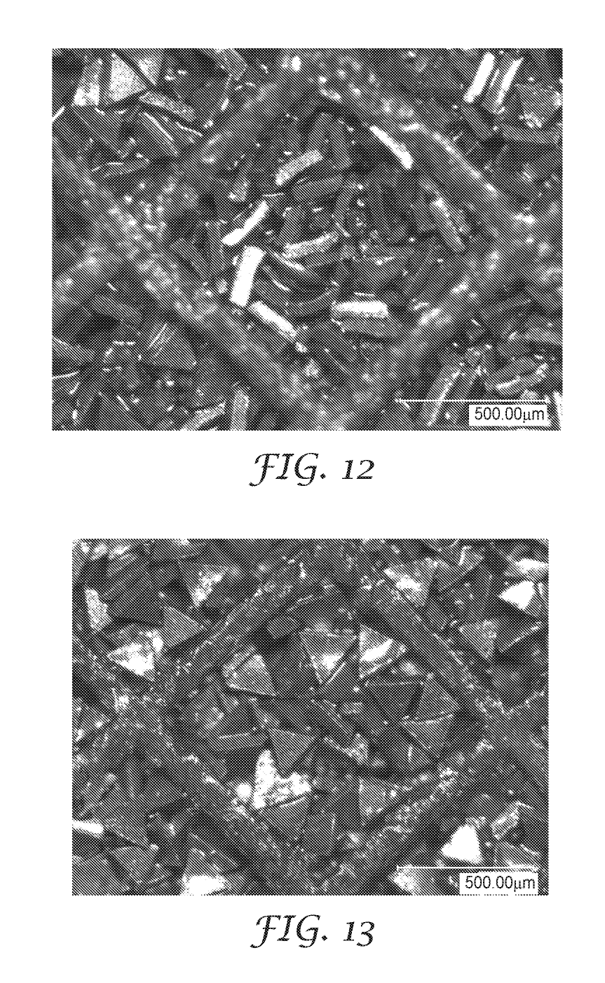

The procedure described above in EXAMPLE 5 was repeated, except that the slurry was filled into the tooling without ever being subjected to the magnetic field. The magnetizable agglomerate abrasive precursor particles in the dried sample had a random orientation distribution as shown in FIG. 13.

### Example 7

A slurry of 500 grams was prepared by mixing the components listed in Table 6 using a high-shear mixer. The resultant slurry was coated into equilateral triangle-shaped polypropylene mold cavities of 2.67 mm side length×0.90 mm thick, with a draft angle approximately 98 degrees. The sample was cured at 76.7° C. for 24 hours. After curing, the particles were removed from the tooling using an ultrasonic horn.

TABLE 6

| COMPOSITION | WEIGHT PERCENT |
|---|---|
| PR | 30.3% |
| Isopropyl Alcohol | 9.7% |
| SAP | 40.0% |
| MP | 20.0% |

### Example 8

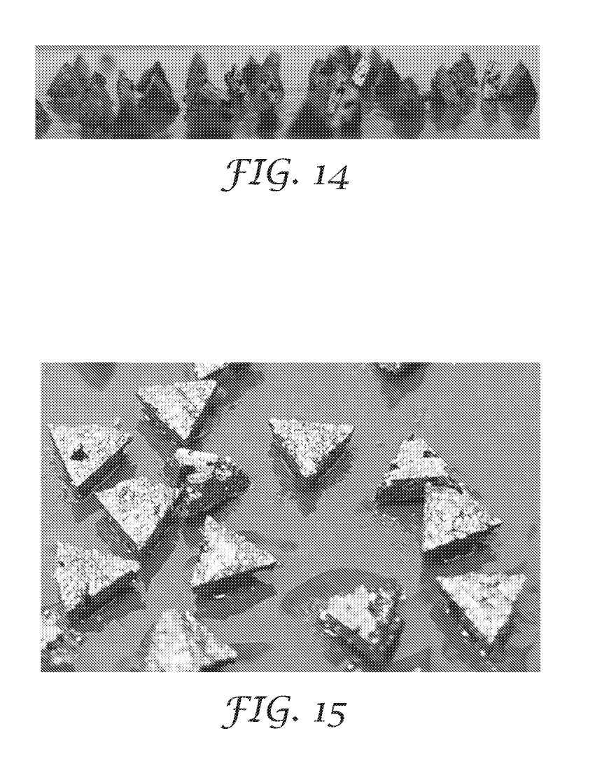

A precut vulcanized fiber disc blank with a diameter of 7 inches (17.8 cm), having a center hole of ⅞ inch (2.2 cm) diameter and a thickness of 0.83 mm (33 mils) obtained as DYNOS VULCANIZED FIBRE from DYNOS GmbH, Troisdorf, Germany was coated with 269.9 g/m² of a phenolic make resin consisting of 49.2 parts of PR, 40.6 parts of calcium metasilicate (obtained as WOLLASTOCOAT from NYCO Company, Willsboro, N.Y.), and 10.2 parts of water. A brush was used to apply the resin. Magnetizable agglomerate abrasive particles prepared in EXAMPLE 7 were drop coated onto the make resin-coated backing while sitting on the face of a 6-inch (15.2-cm) diameter by 2-inch (5.1-cm) thick permanent neodymium magnet with an average magnetic field of 0.6 Tesla. The magnetizable agglomerate abrasive particles oriented upright and affixed to the resin-coated backing. The backing was then placed in an oven at 87.8° C. for 100 minutes, followed by 12 hours at 102.8° C. The magnetizable agglomerate abrasive particles remained upright after the cure cycle as shown in FIG. 14.

### Example 9

A precut vulcanized fiber disc blank with a diameter of 7 inches (17.8 cm), having a center hole of ⅞ inch (2.2 cm) diameter and a thickness of 0.83 mm (33 mils) obtained as DYNOS VULCANIZED FIBRE from DYNOS GmbH, Troisdorf, Germany was coated with 269.9 g/m² of a phenolic make resin consisting of 49.2 parts of PR, 40.6 parts of calcium metasilicate (obtained as WOLLASTOCOAT from NYCO Company), and 10.2 parts of water. A brush was used to apply the resin. Agglomerates prepared in EXAMPLE 7 were drop coated onto the make resin-coated backing without being subjected to the magnetic field. The particles fell flat on their sides and affixed to the resin-coated backing. The backing was then placed in an oven at 87.8° C. for 100 minutes, followed by 12 hours at 102.8° C. The particles remained lying flat after the cure cycle as shown in FIG. 15.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1-16. (canceled)

17. A magnetizable agglomerate abrasive particle comprising magnetizable particles and constituent abrasive particles retained in a binder material, wherein the magnetizable particles and the constituent abrasive particles are unassociated, and wherein the magnetizable particles have a Mohs hardness of 6 or less.

18. The magnetizable agglomerate abrasive particle of claim 17, wherein the binder matrix comprises a vitreous binder material.

19. A magnetizable agglomerate abrasive particle comprising magnetizable abrasive particles retained in a binder material, wherein each magnetizable abrasive particle comprises a respective ceramic body and a magnetizable layer disposed on at least a portion of the ceramic body.

20. The magnetizable agglomerate abrasive particle of claim 19, wherein the magnetizable abrasive particles each have two opposed major facets connected to each other by a plurality of side facets, and wherein a majority of the magnetizable abrasive particles have at least one of the major facets aligned substantially perpendicular to a common plane.

21. The magnetizable agglomerate abrasive particle of claim 17, wherein the abrasive particles comprise shaped abrasive particles.

22. The magnetizable agglomerate abrasive particle of claim 17, wherein the binder matrix is vitreous.

23. The magnetizable agglomerate abrasive particle of claim 17, wherein the binder matrix comprises crosslinked organic polymer.

24. A plurality of magnetizable agglomerate abrasive particles according to claim 1.

25. An abrasive article comprising a plurality of magnetizable agglomerate abrasive particles according to claim 24 retained in a second binder material.

26. An abrasive article according to claim 25, wherein the abrasive article comprises a bonded abrasive wheel.

27. An abrasive article according to claim 25, wherein the abrasive article comprises a coated abrasive article, wherein the coated abrasive article comprises an abrasive layer disposed on a backing, and wherein the abrasive layer comprises the second binder matrix and the plurality of magnetizable agglomerate abrasive particles.

28. An abrasive article according to claim 27, wherein the abrasive layer comprises make and size layers.

29. An abrasive article according to claim 25, wherein the abrasive article comprises a nonwoven abrasive, wherein the nonwoven abrasive comprises a nonwoven fiber web having an abrasive layer disposed on at least a portion thereof, and wherein the abrasive layer comprises the second binder matrix and the plurality of magnetizable agglomerate abrasive particles.

30. A method of making an agglomerate abrasive particle, the method comprising steps:
a) filling a cavity of a mold with a slurry comprising a binder precursor and magnetizable abrasive particles;
b) applying a magnetic field to orient the magnetizable abrasive particles; and
c) at least one of drying or curing the binder precursor sufficient to fix the respective orientations of the magnetizable abrasive particles.

31. The method of claim 30, wherein steps b) and c) are sequential.

32. The method of claim 30, wherein steps b) and c) are simultaneous.
